(19) United States
(12) Patent Application Publication
(10) Pub. No.: US 2023/0317944 A1
(43) Pub. Date: Oct. 5, 2023

(54) FLUORINATED ELECTRODES AND BATTERIES CONTAINING THE SAME

(71) Applicant: CARNEGIE MELLON UNIVERSITY, Pittsburgh, PA (US)

(72) Inventors: Venkatasubramanian VISWANATHAN, Pittsburgh, PA (US); Venkatesh KRISHNAMURTHY, Pittsburgh, PA (US)

(21) Appl. No.: 18/022,440

(22) PCT Filed: Nov. 19, 2021
(86) PCT No.: PCT/US2021/060030

§ 371 Date: Feb. 21, 2023

Related U.S. Application Data
(60) Provisional application No. 63/115,674, filed on Nov. 19, 2020.

(51) Int. Cl. H01M 4/58; H01M 50/46; H01M 4/04

(52) U.S. Cl. CPC H01M 4/582; H01M 50/46; H01M 4/049; H01M 2004/028

(57) ABSTRACT

In some aspects, the present disclosure is directed to fluorinated electrodes that comprises layers of AFₓ, where A is a single-element material selected from B, Al, Si, and P or a multi-element material comprising two different elements selected from B, C, N, Al, Si, and P, where F is fluorine, where x is the degree to which A is fluorinated on an atom basis, and where x is between 0.5 to 20. In other aspects, the present disclosure is directed to batteries that contain such fluorinated electrodes and to methods of making such fluorinated electrodes.

### RELATED APPLICATION

This application claims the benefit of U.S. Provisional Patent Application No. 63/115,674, filed Nov. 19, 2021, entitled “Fluorinated Electrodes and Batteries Thereof”, the contents of which are incorporated by reference herein in their entirety.

### FIELD

The present disclosure relates generally to the field of batteries, including lithium-ion batteries, and more particularly to fluorinated cathodes for use in such batteries.

### BACKGROUND

CFₓ(x=0.5−1.12) (Mitkin, V. N. J. Struct. Chem. 2003, 44, 82-115) are solid fluorinated carbon polymers, synthesized by reacting graphite or other carbon sources with fluorine gas at elevated temperatures of 100-600° C. CFₓ was first synthesized in 1934 (Ruff, O., Bretschneider, O. Z. Anorg. Allg. Chem. 1934, 217, 1-18), and it was used as a cathode material in lithium-ion batteries in the 1970s (Watanabe, N.; Fukuda, M. Primary cell for electric batteries. U.S. Pat. No. 3,536,532, Oct. 27, 1970; Watanabe, N.; Fukoda, M. High energy density battery. U.S. Pat. No. 3,700,502, Oct. 24, 1972). Although they retain the layered structure of graphite, the individual layers are non-planar due to the change in the hybridization of carbon from sp² to sp³ upon fluorination. CFₓ electrodes, however, currently suffer from poor discharge rate, heat generated during discharge, and no rechargeability.

### SUMMARY

In some aspects, the present disclosure is directed to fluorinated electrodes that comprise layers of AFₓ, where A is a single-element material selected from B, Al, Si, and P, or a multi-element material comprising two different elements selected from B, C, N, Al, Si, and P, where F is fluorine, where x is the degree to which A is fluorinated on an atom basis, and where x is between 0.5 to 20.

In some embodiments, which can be used in conjunction with any of the above aspects and embodiments, a minor amount of the fluorine atoms in the fluorinated electrode may be substituted by one or more halogen atoms other than fluorine (e.g., Cl, Br, I, etc.). Generally, less than 10% of the fluorine atoms are substituted by one or more halogen atoms other than fluorine, typically less than 5%, even more typically less than 1%.

In some embodiments, which can be used in conjunction with any of the above aspects and embodiments, the fluorinated electrode comprises a minor amount of one or more dopants selected from Li, Be, B, Na, Mg, Al, Si, K, Ca, Sc, Ti, V, Cr, Mn, Fe, Co, Ni, Cu, Zn, Ga, Ge, Rb, Sr, Y, Zr, Nb, Mo, Tc, Ru, Rh, Pd, Ag, Cd, In, Sn, Sb, Cs and Ba. For instance, the fluorinated electrode may comprise from 0.01 atomic % or less to 10 atomic % or more of the one or more dopants, based on the total number of A atoms.

Examples of multi-element material A include two-element compounds such as SiC, BN, AlN, BP, or AlP (including hexagonal crystalline forms of SiC, BN, AlN, BP, AlP), heterostructure materials based on two different single-element materials, heterostructure materials based on both a single-element material and a two-element compound, and heterostructure materials based on two different two-element compounds, among other possibilities

Other aspects of the present disclosure pertain to methods of forming fluorinated electrodes in accordance with any of the above aspects and embodiments. In these aspects, fluorinated electrodes may be formed by a process in which a starting precursor material A in accordance with any of the above aspects and embodiments, is fluorinated to the degree x. Fluorination may be carried out by reacting the precursor material A with the fluorine gas or reacting the precursor material A with another suitable fluorine containing source.

Other aspects of the present disclosure are directed to batteries that comprise at least one electrochemical cell that comprises (a) an anode, (b) a cathode selected from a fluorinated electrode that comprises layers of AFₓ, in accordance with any of the above aspects and embodiments, and (c) an electrolyte disposed between the cathode and the anode.

In some embodiments, the anode comprises a metal.

In some embodiments, which can be used in conjunction with the above aspects, the anode comprises a metal selected from lithium, sodium, potassium, zinc, magnesium, and aluminum, and the anode is selected from a lithium-containing anode, a sodium-containing anode, a potassium-containing anode, a zinc-containing anode, a magnesium-containing anode, and an aluminum-containing anode.

In some embodiments, which can be used in conjunction with any of the above aspects and embodiments, the electrolyte contains ions of the metal, for example, selected from lithium ions, sodium ions, potassium ions, zinc ions, magnesium ions, and aluminum ions.

In some embodiments, which can be used in conjunction with any of the above aspects and embodiments, the cathode comprises intercalated ions of the metal, for example, selected from lithium ions, sodium ions, potassium ions, zinc ions, magnesium ions, and aluminum ions.

In some embodiments, which can be used in conjunction with any of the above aspects and embodiments, the electrolyte may be selected from a liquid electrolyte and a solid electrolyte.

In some embodiments, which can be used in conjunction with any of the above aspects and embodiments, the electrochemical cell further comprises an ionically conductive separator between the cathode and the anode.

In some embodiments, which can be used in conjunction with any of the above embodiments, the battery has a specific energy ranging from 100 Wh/kg to 1000 Wh/kg.

In some embodiments, the metal is lithium and the battery is a lithium-ion battery, in which case the specific energy may be greater than, for example, about 600 Wh/kg and have high discharging and charging currents.

In some embodiments, the metal is selected sodium, potassium, magnesium, zinc, and aluminum, and the battery is metal-ion battery, in which case the specific energy may be greater than, for example, about 400 Wh/kg and have high discharging and charging currents.

### BRIEF SUMMARY OF THE DRAWINGS

FIG. 1 is a schematic illustration of an electrochemical cell in accordance with the present disclosure.

FIG. 2 is a schematic illustration of a portion of a periodic table of elements.

### DETAILED DESCRIPTION

As previously noted, in some aspects, the present disclosure is directed to fluorinated electrodes that comprises layers of AFT, where A is a single-element material selected from B, Al, Si, and P or a multi-element material comprising two different elements selected from B, C, N, Al, Si and P, where F is fluorine, and where x is the degree to which A is fluorinated on an atom basis.

More broadly, in some aspects, the present disclosure relates to a fluorinated electrode that comprises layers of AFT, where A is a single-element material selected from suitable non-carbon elements shown in FIG. 2 or a multi-element material comprising two different suitable elements selected from suitable elements shown in FIG. 2, where F is fluorine, and where x is the degree to which A is fluorinated on an atom basis.

In some embodiments, the degree of fluorination x ranges from 0.5 to 20. For instance, the degree of fluorination x may range anywhere from 0.5 to 0.75 to 1 to 1.5 to 2 to 5 to 10 to 15 to 20 (in other words, ranging between any two of the preceding values).

In some embodiments wherein A is a single-element material selected from B, Al, Si and P, the fluorinated electrode may comprise layers of fluorinated boron (BF_{X},), fluorinated aluminum (AlF_{X},), fluorinated silicon (SiF_{X},), or fluorinated phosphorous (PF_{X},). In certain embodiments, A may correspond to the hexagonal crystalline form of the single-element material.

In some embodiments where A is a multi-element material comprising two different elements selected from B, C, N, Al, Si, and P, A may correspond to the hexagonal crystalline form of the multi-element material.

Examples of multi-element materials A include two-element compounds such as SiC, BN, AlN, BP, or AlP (including the hexagonal crystalline forms of SiC, BN, AlN, BP or AlP). Moreover, the fluorinated electrode may comprise layers of fluorinated silicon carbide (SiCF_{X}), fluorinated boron nitride (BNF_{X}), fluorinated aluminum nitride (AlNF_{X}), fluorinated boron phosphide (BPF_{X}) or fluorinated aluminum phosphide (AlPF_{X}).

Examples of multi-element materials further include heterostructure materials based on two different single-element materials such as a material A|A′ where A and A′ designate different single-element materials, and where the heterostructure material may comprise layers of A and layers of A′. Specific examples of such materials include B|C, B|Al, B|Si, B|P, C|Al, C|Si, C|P, Al|Si, Al|P, or Si|P. Moreover, the fluorinated electrode may comprise layers of fluorinated B|C (e.g., (B|C)F_{X}), fluorinated B|Al (e.g., (B|AI)F_{X}), fluorinated B|Si (e.g., (B|Si)F_{X}), fluorinated B|P (e.g., (B|P)F_{X}), fluorinated C|Al (e.g., (C|Al)F_{X}), fluorinated C|Si (e.g., (C|Si)F_{X}), fluorinated C|P (e.g., (C|P)F_{X}), fluorinated Al|Si (e.g., (Al|Si)F_{X}), fluorinated Al|P (e.g., (Al|P)F_{X}), or fluorinated Si|P (e.g., (Si|P)F_{X}).

Examples of multi-element materials further include heterostructure materials based on a single-element material and a two-element compound such as a material A|A′A″ where A designates a single-element material, where A′A″ designates a two-element compound, and where the heterostructure material may comprise layers of A and layers of A′A″. Specific examples of such materials include B|SiC, B|BN, B|AlN, B|BP, B|AlP, C|SiC, C|BN, C|AlN, C|BP, C|AlP, Al|SiC, Al|BN, Al|AlN, Al|BP, Al|AlP, Si|SiC, Si|BN, Si|AlN, Si|BP, Si|AlP, P|SiC, P|BN, P|AlN, P|BP, or P|AlP. Moreover, the fluorinated electrode may comprise layers of fluorinated B|SiC (e.g., (B|SiC)F_{X}), fluorinated B|BN (e.g., (B|BN)F_{X}), fluorinated B|AlN (e.g., (B|AlN)F_{X}), fluorinated B|BP (e.g., (B|BP)F_{X}), fluorinated B|AlP (e.g., (B|AlP)F_{X}), fluorinated C|SiC (e.g., (C|SiC)F_{X}), fluorinated C|BN (e.g., (C|BN)F_{X}), fluorinated C|AlN (e.g., (C|AlN)F_{X}), fluorinated C|BP (e.g., (C|BP)F_{X}), fluorinated C|AlP (e.g., (C|AlP)F_{X}), fluorinated Al|SiC (e.g., (Al|SiC)F_{X}), fluorinated Al|BN (e.g., (Al|BN)F_{X}), fluorinated Al|AlN (e.g., (Al|AlN)F_{X}), fluorinated Al|BP (e.g., (Al|BP)F_{X}), fluorinated Al|AlP (e.g., (Al|AlP)F_{X}), fluorinated Si|SiC (e.g., (Si|SiC)F_{X}), fluorinated Si|BN (e.g., (Si|BN)F_{X}), fluorinated Si|AlN (e.g., (Si|AlN)F_{X}), fluorinated Si|BP (e.g., (Si|BP)F_{X}), fluorinated Si|AlP (e.g., (Si|AlP)F_{X}), fluorinated P|SiC (e.g., (P|SiC)F_{X}), fluorinated P|BN (e.g., (P|BN)F_{X}), fluorinated P|AlN (e.g., (P|AlN)F_{X}), fluorinated P|BP (e.g., (P|BP)F_{X}), or fluorinated P|AlP (e.g., (P|AlP)F_{X}).

Examples of multi-element materials further include heterostructure materials based on two different two-element compounds such as a material A′A|A″A′A″ ″ where A′A″ and A′″A″ ″ designate two different two-element compounds, and where the heterostructure material may comprise layers A′A″ and layers of A′″A″ ″. Specific examples of such materials include SiC|BN, SiC|AlN, SiC|BP, SiC|AlP, BN|AlN, BN|BP, BN|AlP, AlN|BP, AlN|AlP, or BP|AlP. Moreover, the fluorinated electrode may comprise layers of fluorinated SiC|BN (e.g., (SiC|BN)F_{X}), fluorinated SiC|AlN (e.g., (SiC|AlN)F_{X}), fluorinated SiC|BP (e.g., (SiC|BP)F_{X}), fluorinated SiC|AlP (e.g., (SiC|AlP)F_{X}), fluorinated BN|AlN (e.g., (BN|AlN)F_{X}), fluorinated BN|BP (e.g., (BN|BP)F_{X}), fluorinated BN|AlP (e.g., (BN|AlP)F_{X}), fluorinated AlN|BP (e.g., (AlN|BP)F_{X}), fluorinated AlN|AlP (e.g., (AlN|AlP)F_{X}), or fluorinated BP|AlP (e.g., (BP|AlP)F_{X}).

In some embodiments, a minor amount of the fluorine atoms in the fluorinated electrodes of the present disclosure may be substituted by one or more halogen atoms other than fluorine (e.g., Cl, Br, I, etc.). Generally, less than 10% of the fluorine atoms are substituted by one or more halogen atoms other than fluorine, typically less than 5%, even more typically less than 1%.

In some embodiments, the fluorinated electrodes of the present disclosure comprise a minor amount of one or more dopants selected from Li, Be, B, Na, Mg, Al, Si, K, Ca, Sc, Ti, V, Cr, Mn, Fe, Co, Ni, Cu, Zn, Ga, Ge, Rb, Sr, Y, Zr, Nb, Mo, Tc, Ru, Rh, Pd, Ag, Cd, In, Sn, Sb, Cs and Ba. For instance, the fluorinated electrode may comprise from 0.01 atomic % or less to 10 atomic % or more of the one or more dopants, based on the total number of A atoms, for example, ranging anywhere from 0.01 atomic % to 0.02 atomic % to 0.05 atomic % to 0.1 atomic % to 0.2 atomic % to 0.5 atomic % to 1 atomic % to 2 atomic % to 5 atomic % to 10 atomic % of the one or more dopants.

Other aspects of the present disclosure pertain to methods of forming fluorinated electrodes in which a starting precursor material A in accordance with any of the above aspects and embodiments (e.g., where A is a single-element material selected from B, Al, Si, and P or a multi-element material comprising two different elements selected from B, C, N, Al, Si and P, etc.) is fluorinated to the degree x. Fluorination may be carried reacting the precursor material A with the fluorine gas (e.g., at elevated temperature) or reacting the precursor material A with another suitable fluorine containing source.

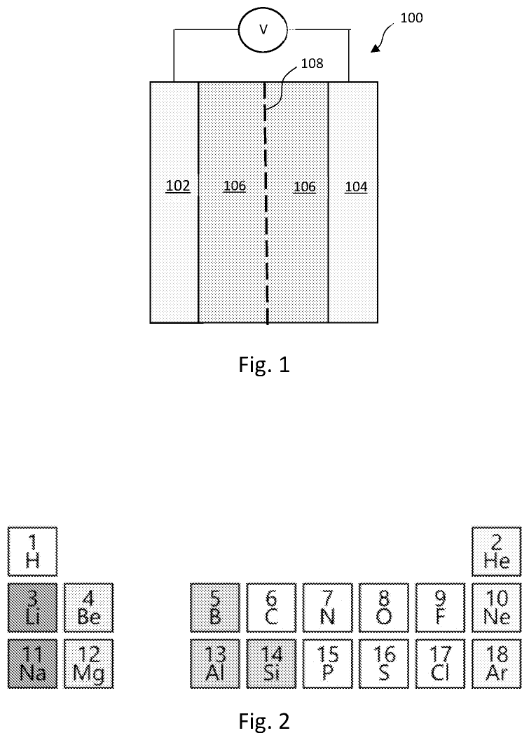

Fluorinated electrodes such as those described above may be used in electrochemical cells, including those found in energy storage batteries. For example, with reference to the schematic illustration of FIG. 1, an electrochemical cell 100 is shown which includes (a) an anode 102, (b) a cathode 104, which corresponds to a fluorinated electrode such as those described elsewhere herein, and (c) an electrolyte 108 disposed between the cathode and the anode. V in FIG. 1 may designate either a discharge voltage or a charging voltage, depending on the circumstances. In some embodiments, the anode is a metal-containing anode 102, which may be, for example, selected from a lithium anode, a sodium anode, a potassium anode, a zinc anode, a magnesium anode, and an aluminum anode. The electrolyte 106 may correspond, for example, to a liquid electrolyte or a solid electrolyte. The electrolyte 106 may contain ions corresponding to a metal in the metal-containing anode 102, for example, selected, for example, from lithium ions, sodium ions, potassium ions, zinc ions, magnesium ions, and aluminum ions. Similarly, the cathode 104 may contain intercalated ions corresponding to a metal in the metal-containing anode 102, for example, intercalated ions selected from lithium ions, sodium ions, potassium ions, zinc ions, magnesium ions, and aluminum ions.

In the embodiment shown in FIG. 1 the electrochemical cell 100 further comprises an ionically conductive separator 108 disposed between the cathode and the anode. The ionically conductive separator allows for conduction of ions between the cathode and the anode, while at the same time preventing an internal short-circuit between the two electrodes. For example, a separator made of porous glass or a porous polymer such as porous polypropylene may be included for this purpose, among others.

Without being bound by theory, it is believed that the AFₓ compounds modify the nature of bonding upon discharge between M-F (e.g. Li—F), where M is a metal that may be lithium, sodium, potassium, zinc, magnesium, or aluminum, from ionic to covalent, through mediating the local electronic structure, leading to improved discharge rate, lower heat generated during discharge and rechargeability. In embodiments where the fluorinated electrode is used in an electrochemical cell that includes a lithium-containing cathode potential identification rules for a suitable material A are given below.

AF, identification: The stability of a lithiated phase of fluorine along with a given stabilizing component A is determined by the stability of LiAF vs LiF and A; LiF and LiA. The stability of LiA is determined by the electronegativity of A, while stability of A is determined by its inherent bond strength. Based on this analysis, it is found that the stabilizing elements may come from the boron, carbon, nitrogen group or combinations thereof, with additive amounts of other elements that could be selected from those listed in FIG. 2. The materials may be downselected by applying the following selection constraints.

Thermodynamics of Lithium intercalation reaction: The energetics of the lithiated phase U^{o}=E_{LiYAFx}−yE_{Li}−E_{AFx} is less than −3 eV. This number can be determined through density functional theory calculations of the solid phases, LiyAFₓ, Li, AFₓ.

Small volume change under lithiation: Volume change upon lithiation, given by ΔV=V_{LiyAFx}−V_{AFx}<α×V_{AFx}, is small, i.e. α<4. This can be determined using density functional theory calculations of the volume of the solid phases, Li_{y}AFₓ and AFₓ.

Electronically Conducting: The material AFₓ and Li_{y}AFₓ have band gaps less than 2 eV. This can be determined using density functional theory calculations of the band structure of the solid phases, Li_{y}AFₓ and AFₓ.

Representative examples for A: Applying these selection criterion, single-element materials A may be selected from B, C, P, Si and Al and multi-element materials may contain two elements selected from the list shown in FIG. 2, more particularly, two elements selected from B, C, N, Al, Si, and P. As previously indicated, examples of multi-element materials A include two-element compounds such as SiC, BN, AlN, BP, or AlP, heterostructure materials based on two different single-element materials, heterostructure materials based on a single-element material and a two-element compound, and heterostructure materials based on two different two-element compounds. These are meant to be a representative set and are not exhaustive.

Degree of Fluorination and Lithiation: The degree of fluorination x is between 0.5 to 20 and can be modified through known fluorination approaches. The degree of lithiation, y will typically be less than or equal to x, but in in some cases (Li-rich cathodes), y may exceed x.

1. A fluorinated electrode that comprises layers of AF, where A is a single-element material selected from B, Al, Si, and P or a multi-element material comprising two different elements selected from B, C, N, Al, Si, and P, where F is fluorine, where x is the degree to which A is fluorinated on an atom basis, and where x is between 0.5 to 20.

2. The fluorinated electrode of claim 1, wherein less than 10% of the fluorine atoms are substituted by one or more halogen atoms other than fluorine.

3. The fluorinated electrode according to any of claims 1-2, further comprising from 0.01 atomic % to 10 atomic %, based on the total number of A atoms, of one or more dopants selected from Li, Be, B, Na, Mg, Al, Si, K, Ca, Sc, Ti, V, Cr, Mn, Fe, Co, Ni, Cu, Zn, Ga, Ge, Rb, Sr, Y, Zr, Nb, Mo, Tc, Ru, Rh, Pd, Ag, Cd, In, Sn, Sb, Cs and Ba.

4. The fluorinated electrode according to any of claims 1-3, wherein A is the single-element material.

5. The fluorinated electrode according to claim 4, wherein A corresponds to the hexagonal crystalline form of the single-element material.

6. The fluorinated electrode according to any of claims 1-3, wherein A is the multi-element material.

7. The fluorinated electrode according to claim 6, wherein A corresponds to the hexagonal crystalline form of the multi-element material.

8. The fluorinated electrode according to any of claims 6-7, wherein the multi-element material is a two-element compound selected from SiC, BN, AlN, BP and AlP.

9. The fluorinated electrode according to any of claims 6-7, wherein the multi-element material is selected from a heterostructure material based on two different single-element materials, a heterostructure material based on a single-element material and a two-element compound, and a heterostructure material based on two different two-element compounds.

10. A method of forming a fluorinated electrode in accordance with any of claims 1-9 comprising fluorinating a starting precursor material A to the degree x.

11. The method of claim 10, wherein the starting precursor material A is fluorinated by reacting the precursor material A with fluorine gas.

12. A battery comprising at least one electrochemical cell that comprises (a) an anode, (b) a cathode comprising a fluorinated electrode in accordance with any of claims 1-9, and (c) an electrolyte disposed between the cathode and the anode.

13. The battery of claim 12, wherein the anode is selected from a lithium-containing anode, a sodium-containing anode, a potassium-containing anode, a zinc-containing anode, a magnesium-containing anode, and an aluminum-containing anode.

14. The battery according to claim 13, wherein the electrolyte contains ions selected from lithium ions, sodium ions, potassium ions, zinc ions, magnesium ions, and aluminum ions.

15. The battery according to any of claims 13-14, wherein the cathode comprises intercalated ions selected from lithium ions, sodium ions, potassium ions, zinc ions, magnesium ions, and aluminum ions.

16. The battery according to any of claims 12-15, wherein the electrolyte is selected from a liquid electrolyte and a solid electrolyte.

17. The battery according to any of claims 12-16, wherein the electrochemical cell further comprises an ionically conductive separator between the cathode and the anode.

18. The battery according to any of claims 12-17, wherein the battery has a specific energy ranging from 100 Wh/kg to 2000 Wh/kg.

19. The battery according to any of claims 12-18, wherein the anode is a lithium-containing anode and wherein the battery has a specific energy is greater than about 600 Wh/kg.

20. The battery according to any of claims 12-18, wherein the anode is selected from a sodium-containing anode, a potassium-containing anode, a zinc-containing anode, a magnesium-containing anode, and an aluminum-containing anode, and wherein the battery has a specific energy greater than about 400 Wh/kg.
